(19) United States
(12) Patent Application Publication
(10) Pub. No.: US 2003/0226401 A1
(43) Pub. Date: Dec. 11, 2003

(54) Atomic structure recognition and modification method and apparatus

(76) Inventor: Howard Letovsky, Willits, CA (US)

Correspondence Address: HOWARD LETOVSKY, P.O. Box 1925, WILLITS, CA, 95490, US

(21) Appl. No.: 10/165,648

(22) Filed: Jun. 6, 2002

(51) Int. Cl. G01N 29/00

(52) U.S. Cl. 73/579

(57) ABSTRACT

The present invention provides methods and apparatus for determining the precise makeup of atomic and molecular structures, as well as providing the capability of modifying said structures. The invention uses induced resonant frequency wave effects to define and modify the electromagnetic, electrical, radioactive, atomic weight, and co-valent bonding characteristics of matter. One embodiment of the present invention may produce directionally controllable magnetic fields in gaseous media that interact with magnetically polarized vehicle surfaces to allow high-speed, highly energy efficient inter-planetary space travel. Another embodiment of the invention may neutralize waste products remaining from nuclear fission power production. The invention utilizes controlled multi-spectrum frequency induction to catalyze changes in atomic structures that may include: focused and dramatically amplified release of energy relative to natural states of matter; production of new alloys; transmutation of dangerous organic compounds into non-toxic media; and controlled polarization of matter. The benefits of the invention may include highly efficient interstellar spacecraft propulsion systems, hazardous waste elimination systems, efficient electricity production, and health enhancement of biological organisms.

### BACKGROUND

1. Field of Invention

The present invention relates generally to apparatus and processes that recognize and affect the structure, internal bonds, electrostatic characteristics, and electromagnetic polarization of atoms and molecules.

2. Description of Prior Art

Various devices are used to determine the atomic and molecular makeup of organic and inorganic substances. A gas chromatograph does this to a degree by vaporizing matter at high temperatures, and analyzing the components as they are freed from the material matrix. Many variations of spectrum analyzers are used to determine material components by using frequency reflection amplitude analysis. Magnetic resonance imaging systems create visual representations of varying organic forms by digitally deciphering interference patterns of electromagnetic frequencies applied to tissues. The science of chemistry uses reagents to determine material makeup. Infrared imaging systems use narrow spectrum light frequency sensors to see through fog. Thermal imaging systems use temperature variant sensors to see in the dark. In the animal kingdom, dolphins use advanced sonar transceiving senses to find hidden prey in the sea floor, as well as allegedly penetrate human bodies with healing frequencies. Recent evidence suggests that dogs may have the ability to “smell” cancer in humans.

Simpson's U.S. Pat. No. 5,377,163 describes a broadband acoustic sonar system designed to determine the species of various underwater life forms. Though Simpson's system embodies several of the key elements of the present invention, it operates in a very narrow acoustic frequency range only, and is only designed to recognize various types of fish. In U.S. Pat. No. 5,343,443, Merewether discloses a broadband acoustic transducer which is used in various examples of prior art, and is exemplary of the types of sensors used in material recognition technologies. In U.S. Pat. No. 5,325,703, Magori discloses an apparatus and method for identifying the concentration of fuels or gases in air, by directing ultrasound through a mixture in the measuring section, and determining the speed of sound through the air/vapor mixture.

The key limitations of the foregoing examples, and all other relevant prior art, is the tendency to focus on narrow segments of the total frequency spectrum, Further, prior art does not recognize the importance of classifying the amplitudes of transmitted (as opposed to reflected), absorbed, and especially active resonant frequencies as they pass through atomic structures as a primary key to defining atomic makeup. Further, prior art does not combine transmitted closed loop broadband active resonant frequency manipulation with frequency wave characteristics classification. Because of these deficiencies, no prior art system provides a means to determine the atomic and molecular makeup of virtually all ranges of matter. The present invention provides said means by integrating a full range of design elements required to both identify and subsequently affect, the atomic and molecular components of virtually all known forms of matter.

Modern industry relies primarily on thermodynamic and chemical technologies to alter molecular bonds, synthesize materials, and create alloys. Yet, it has also long been understood that frequency waves in ranges from subsonic to microwave and beyond can have profound effects on matter. Wind moving over bridges in precise resonant waves can cause them to come apart. Atomic explosions have shown that the radiated wave outputs of fission chain reactions can shut down electrical devices from great distances. Microwave ovens, magnetic resonance imaging, laser beams, and the classic example of a high “C” note shattering a glass are more benign examples of the molecular recognition and transformation effects of resonant frequency induction effects known in prior art.

Narrow range molecular configuration recognition and transformation technology is exemplified by Paul Gourley's real-time laser reflection biopsy “smart knife” used for precise surgical applications. Stan Myers patents on splitting water into hydrogen and oxygen with focused frequency waves demonstrate additional molecular transformation technology. Infrared lights have long been used as therapeutic tools for relief of muscle pain. Plants use photosynthesis to “transmute” or transform organics and photons into nutrients. Canadian inventor John Hutchison has demonstrated dramatic effects on matter following complex electromagnetic frequency and voltage induction—effects that range from levitation to structural crystalline transformations. Another example of the underlying capabilities of frequency manipulation is sound neutralizing technologies that transmit an exact sonic inverse waveform at an incoming sound wave form to eliminate the sound wave.

Space, water, and land based transportation systems have been primarily dependant on fixed-point propulsion source technology since their inception. A wheel connected to a vehicle contacts a small area of a given surface, and a rotational force is applied to the wheel to effect movement of the vehicle. Propellers, as with wheels, convert force into movement of a vehicle through a relatively small surface area of contact with the surrounding medium. Rocket and jet engines use an assortment of fuels that are directed at an outlet or venturi to create thrust. Once again, a large amount of energy is focused through a small area to move a vehicle. This is not an efficient approach for long range, high speed interstellar vehicles. Nicolai Tesla disclosed various methods of inducing electrical effects in matter, as did Townsend Brown in his patents on high voltage capacitive propulsion systems. Neither of these inventors, however, provided a specific tool set or methodology to advance the state of the art in planetary or space vehicle propulsion to a functional level. The present invention provides the tools and means to create orders of magnitude greater power to weight ratios over the prior art, and orders of magnitude greater net thrust that is applied in a directionally controllable manner to the entire surface of a vehicle. Furthermore, the invention utilizes the medium surrounding said vehicle as a primary component of said thrust.

In the medical arena, gamma ray and radio telemetry surgical systems such as the “x-knife”, a radio telemetry gamma radiation tool, use focused frequency beams to cauterize, vaporize, or otherwise affect tissue structures. These tools, while effective to varying degrees, have disadvantages in that they are designed around specific narrow frequency ranges. The present invention will define an apparatus that provides tunable, multiple frequency, and focused depth composite wave outputs to affect tissues in extremely precise ways, with a fraction of the amount of energy required to effect tissues relative to other means.

In the area of toxic waste elimination, typical approaches involve sealing dangerous compounds in glass shells, or burying the materials in deep caves. This is about as effective as sweeping a scorpion under a rug. Eventually the scorpion will crawl out and sting someone. The present invention will define an apparatus to transform a radioactive or otherwise toxic compound into an inert substance. Further, it will also provide tools and techniques to increase the radioactive output of a “spent” nuclear fuel.

In the area of food and medicinal plant cultivation, it has been advantageous to control the rate of growth of various parts of plants and their roots. The use of applied frequency waves to produce these effects is gaining popularity, but the current processes used to define the appropriate waves to create a desired effect are time consuming and limited. The present invention defines an apparatus that provides a means to expedite the identification and generation of frequency waves designed to enhance plant growth. Similarly, the invention will also define an apparatus that provides a means for hormone stimulation in humans and animals—effects that are currently achieved with ingestible or injectable drugs.

In the area of defense and law enforcement, research has been ongoing to develop means to neutralize the effectiveness of guided missiles and other “smart” weapons, as well as stop vehicle operational capabilities from a distance. The present invention provides the underlying tools to develop such means—without requiring nearby atomic bomb blasts.

Though it might seem that the wide range of technological arenas, and the associated prior art that have been heretofore described are unrelated, they are, in fact, ultimately related. This will be clarified by the core description, and the ensuing additional embodiment descriptions of the present invention. There is a need for an apparatus that provides a technological foundation for system development and deployment of devices that both identify and subsequently affect the atomic and molecular components of virtually all known forms of matter. The present invention as described herein provides that foundation.

### SUMMARY OF THE INVENTION

The primary objective of the present invention is to provide apparatus and processes which generate and use resonant frequency wave effects to modify the structural, electrostatic, electromagnetic, electrical, radioactive, atomic weight, and co-valent bonding characteristics of matter. Further, said apparatus and processes are also intended to identify the components of matter in real, and/or near real time. The present invention focuses on manipulating all segments of the frequency spectrum, and combines the classification of transmitted, reflected, absorbed—and especially active resonant frequencies—as they pass through atomic structures, with closed loop frequency feedback generation and modulation techniques. This combination of techniques and technologies is the key to the effectiveness of the various embodiments of the present invention.

Another objective of the present invention is to produce directionally controllable electromagnetically polarized fields in solid, liquid, or gaseous media that interact with electromagnetically polarized vehicle surfaces to allow high-speed, highly energy efficient, planetary and inter-planetary space travel. The present invention is capable of achieving this objective by utilizing the entire surface area of a vehicle and the adjacent medium surrounding said vehicle as thrust producing elements to maximize power to weight ratios. Inducing a magnetic field in media that are normally non-magnetic is known in several areas of prior art. Eddy current generators use a spinning magnet to induce magnetic fields in aluminum and other metals. Static electrical generators, the principle of which can be simply demonstrated by combing one's hair and having the hair be attracted to the comb as it is pulled away—provide other means to induce attractive and repulsive forces.

Another objective of the present invention is to provide a means to focus and dramatically amplify the release of energy naturally embodied within matter. The atomic bomb is one example of a massive energy release of matter that is catalyzed with a very crude trigger—a directed explosion that rams one radioactive material into another. Similar levels of energy release—both productive and destructive—can be achieved in a much more subtle way with a lot less noise and unwanted radioactive by-products. Fission based nuclear reactors are an example of applied energy capture from molecular instability. The present invention will provide the capability to reactivate the radioactive output from “spent” nuclear fuel rods, as well as modify and reduce the half-life cycles of said rods. Further, the invention may also enable the use of other materials as fuel sources in nuclear reactor style energy producing environments.

Another objective of the present invention is to provide a means to transmute dangerous compounds into non-toxic media, such as neutralizing waste products remaining from nuclear fission power production, or toxic waste resulting from chemical manufacturing. The present invention will effect these transmutations with a minimum amount of power consumption.

Another objective of the present invention is to provide a means to produce new alloys of similar and dissimilar elements such as metal-plastic bonds and fusions, as well as cellulose-plastic compounds in solution, and an almost infinite array of other novel metal and elemental compounds.

Another objective of the present invention is to provide a means to expedite the identification and generation of frequency waves designed to enhance plant growth. Similarly, the invention will also define an apparatus that provides a means for hormone stimulation in humans and animals—effects that are currently achieved with ingestible or injectable drugs. Further, the apparatus will provide a means to stimulate genetic triggers in biological organisms to provide predetermined cellular modifications.

Another objective of the present invention is to provide a means for splitting water into its hydrogen and oxygen subcomponents so that the hydrogen components can be efficiently used in internal combustion engines.

Another objective of the present invention is to provide the capability to neutralize triggering and guidance systems in missiles and other “smart” vehicles. Similarly, if a goal was to remotely trigger the explosion of landmines buried over a large geographic area, the present invention may be used to generate a resonant pressure wave capable of activating the detonation mechanism of said mines. These properties of the present invention are examples of its usefulness in precisely tailoring electrostatic and electromagnetic properties of frequency waves to emulate those that are crudely generated and radiated during a nuclear explosion.

Another objective of the present invention is to provide non-lethal weapons for—hopefully—defensive purposes—by affecting the nervous systems of biological organisms at a distance, and over a large geographic area. For example, if it were necessary to cause a platoon of soldiers to enter a state of uncontrollable seizures, or lose control of their bowels, the effects may be achieved with a combination of frequencies generated by the invention.

Another objective of the present invention is to provide induced “weightlessness” effects in solid objects, and allow large scale shaping of said objects. There has been much speculation as to the methods used to construct many of the buildings of the ancient Earth. The pyramids and many other megalithic structures were built of materials which not only had to be moved great distances from their quarry sites, but were finished with a level of precision arguably unmatched by today's methods of construction engineering. The technologies provided by the present invention may also be used to produce “tools” to induce anti-gravity effects in matter, as well as cut and shape large materials precisely.

The present invention utilizes controlled multi-spectrum frequency generation, transmission, and induction to catalyze changes in atomic and molecular structures. Single, or combinations of, electronically generated frequencies spanning the sound, light, radio, and electromagnetic wavelength spectra, as well as certain combinations of base frequencies, frequency amplifications, inversions, dissonances, and harmonics, are used to achieve the desired results. The invention integrates broadband frequency generators, transducers, broadband frequency sensors, broadband programmable parametric equalizers, polarity sensors, spectrum analyzers, and computers, to determine the atomic structure of a given organic or inorganic substance to a given molecular depth. A set of “active” resonant frequencies relevant to said substance are defined, and an appropriate set of broadband frequency waves are then generated, combined, and applied to a substance through transducers to achieve a desired result.

The invention as described herein has many advantages over prior art solutions. The uses of the invention include highly efficient interstellar spacecraft propulsion systems, hazardous waste elimination systems, efficient electricity production, and health enhancement of biological organisms. A more complete understanding of the present invention, as well as further features and advantages, will be obtained by reference to the following detailed description and drawings. Preferred embodiments of the present invention will be described in the dependent claims.

### BRIEF DESCRIPTION OF THE DRAWINGS

FIG. 1 illustrates an exemplary apparatus for determining and modifying the structure of matter using a specimen chamber.

FIG. 2 illustrates an exemplary apparatus for determining and modifying the structure of matter in open environments.

FIG. 3 illustrates an exemplary apparatus for modifying the structure of specific types of matter in open environments.

FIG. 4 illustrates an exemplary apparatus for establishing and applying a propulsive force to a vehicle surface, and the surrounding medium.

FIG. 5 illustrates a simplified exemplary apparatus for establishing and applying a propulsive force to a vehicle surface, and the surrounding medium.

### DETAILED DESCRIPTION OF THE INVENTION

Our local planetary system, and especially our planet Earth, is fueled and electro magnetically balanced primarily by the sun, our nearest star—which may be metaphorically classified as a broadband frequency generator powered by a nuclear reactor. At the current point of evolution of the solar system, most forms of inorganic matter are congealed into well defined elemental structures. The organic and sentient life forms present on Earth are organized into molecular forms that continue to evolve, but at a relatively slow pace. At other times in the formation of this sector of the universe, the interactions between the planets and stars catalyzed much more rapid formations and transmutations of the various structures of matter. Magma that escapes from the Earth's core may be a current example of primordial planetary gelatin.

The periodic table of elements maps both the differences and similarities between forms of matter. All atomic elements are comprised of observable, quantifiable numbers of sub-components including protons, electrons, and neutrons. While the sub-components may be identical, the arrangements of said sub-components differentiate one atomic element from another. Further, the arrangements of combinations of elements differentiate one molecule from another.

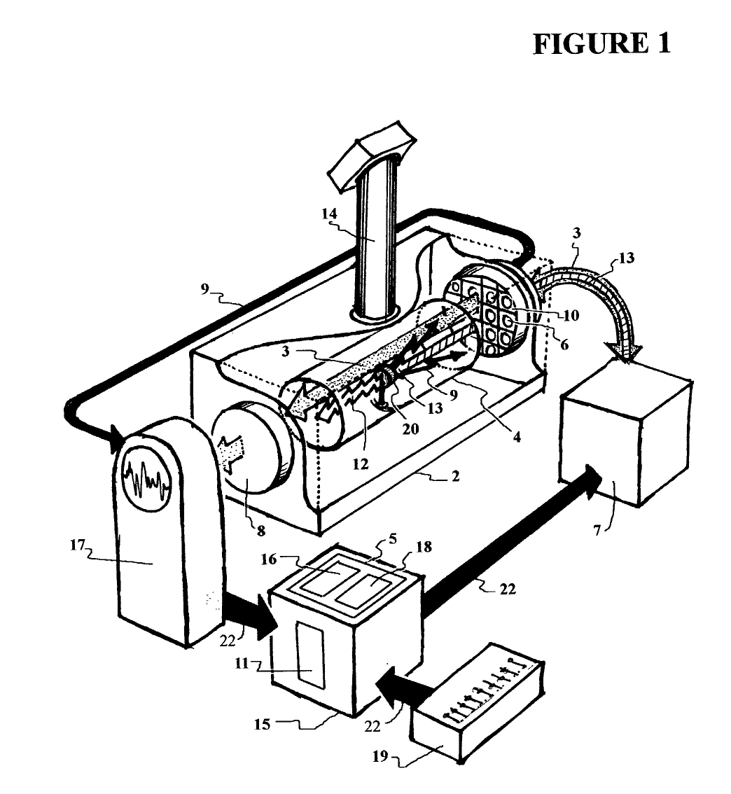

The preferred embodiment of the present invention as shown in FIG. 1 is intended to classify atomic and molecular structures by applying frequency waves drawn from the full range of the electromagnetic frequency spectrum to atomic and molecular structures, and classifying the characteristics and changes of the transmitted, reflected, absorbed, and especially active natural resonant frequency waves as a result of said application. The present invention may then be used to affect and modify said structures with both open and closed loop frequency feedback by manipulating said full range of the electromagnetic frequency spectrum, and applying said modified transmitted, reflected, absorbed, and especially active natural resonant frequency waves to said atomic and molecular structures.

It is well known that molecular structures can be affected by simple combinations of frequencies to achieve a simple result. Crystal can be shattered with the application of a “high C” audio tone. But if the goal were to melt or vaporize the crystal, the present invention may be used to activate and transmit a different base frequency combined with an assortment of multi-order harmonics, frequency inversions, and dissonant frequencies. Further, if the goal were to make the crystal float in the air, a completely different set of effects applied to the crystal and the surrounding medium may be required to be output by the invention.

In the preferred embodiment of the present invention as represented by the flow chart in FIG. 1, a material analysis chamber 2 is provided as an elongated box configured to house a removable specimen-positioning element 4, an array of broadband frequency transmitting transducers 6, an array of broadband frequency receiving transducers 8, and an array of broadband frequency receiving transducers 10. Said receiving and transmitting transducers are mechanically coupled to the interior of material analysis chamber 2, and are well known in prior art, so there is no need to go into specific detail of their makeup herein.

Transducers 10 are mounted interstitially around broadband frequency transmitting transducers 6 to sense reflected frequency waves 9 that radiate back from specimen 20 following generation of broadband frequency waves 3 by frequency generator 7, including any magnetic field radiation. Material analysis chamber 2 may have exterior solid steel walls, but its interior should ideally be rendered frequency neutral with internally mounted sound and light deadening material such as black anechoic foam backed by surface mottled and pocked Mu-metal.

Removable specimen-positioning element 4 may be configured as a frequency neutral container able to hold solids, fluids, or gasses. This may be a clamp, cup, tube, or closed vessel as required. The inherent capabilities of the invention allow both the recognition and frequency neutralization of the removable specimen-positioning element 4 through frequency analysis and feedback settings. An opening in chamber 2, continuing into removable specimen-positioning element 4, may be provided to allow an electron-tunneling microscope 14—or similar test instrument—to be used to observe the effects of the invention on any given specimen 20 restrained by element 4 in real time.

Broadband frequency generator 7 is maintained outside of material analysis chamber 2, but electrically coupled to transducers 6 and capable of generating variable amplitude single or multiple broadband frequency waves 3 from DC to gigahertz ranges and above-combined with single or multiple harmonics and dissonances in said frequency ranges at variable amplitudes. Transducers 6 are configured to transmit and project the broadband frequency waves 3 provided by generator 7 at and through any specimen 20. Frequency receiving transducers 8 and 10 are configured to sense any transmitted frequency 12, and reflected frequency 9 that either pass through, or are rejected by, any specimen 20. Frequency receiving transducers 8 and 10, and frequency transmitting transducers 6, may be configured as an array of multiple segments, each optimized for certain parts of the electromagnetic spectrum. However, the combined capabilities may include every frequency, or combinations of, base frequencies, harmonics, inversions, and dissonances spanning the subsonic, sound, light, radio, and other electromagnetic wavelength spectra.

Spectrum analyzer 17, which is electrically coupled to transducers 8 and 10, as well as computer processing system 15 through an electrical connection 22, performs an analog to digital conversion, as well as frequency amplitude analysis, on said frequency waves 3, 9, and 12. Hardware and software spectrum analyzers, as well as computers, are well known in prior art, so there is no need to go into great detail on these components.

Computer processing system 15 is electrically coupled to generator 7 through an electrical connection 22, and may incorporate a real time software component 11 coded to specify and modify any frequency waves and amplitudes of said wave outputs of generator 7 and the frequency waves 3, 9, and 12 sensed by transducers 8 and 10. This type of software is used in prior art as automatic feedback reducing controls in microprocessor-based stage sound equipment to eliminate feedback from a performer's microphone. The type of software coding and level of detail in software reconfiguration to convert said software to be used in the present invention is not significant, and therefore not necessary to describe in detail. In a simplified embodiment of the present invention, these changes may also be “tuned” by analog style control 19—electrically coupled to generators 7 through an electrical connection 22—which may be a graphic equalizer set well known in prior art.

The combination of spectrum analyzer 17 and system 15 is configured to quantify the absorbed, reflected, and transmitted, single or multiple frequency waves 3, 9, and 12 created by generator 7 and sensed by transducers 8, and 10. Since the output of broadband frequency generator 7 is known through the setup of system 15, the frequencies absorbed by specimen 20 can be determined by algorithms embodied within the software component 11 of system 15 that adds together the reflected and transmitted frequencies in all spectra and subtracts them from the total applied broadband frequency.

A closed loop frequency feedback data set 16 is created by retransmitting only the absorbed frequency waves 13 defined by system 15, and classifying the resultant changes in the associated reflected and transmitted frequency waves 9 and 12. Said data set 16 is configured as a software subset of database 5 of “active natural resonant” frequencies that can be created for any given specimen 20. The active natural resonant frequency makeup of the atomic and molecular structure of a specimen 20 can then be defined by comparing the resultant data quantified by computer processing system 15 with its resident atomic and molecular identification lookup-table data set 18 within database 5. Data set 18 may be continually enhanced as effects are observed and quantified, and changes in any frequency waves 3, 9, 12, and 13 which are output by generator 7 and transducers 6 are catalogued and altered to affect any specimen 20.

Database 5 is structured as a continuously updateable database whose fields expand and records enlarge to encompass all atomic structure change data following frequency inputs generated by frequency generator 7 toward a given specimen 20. Said data includes magnetic polarity changes, proton, neutron, and electron number and radiation shifts, and all spectral analysis changes following said shifts. The algorithm required for building database 5 is suited to a “neural net” configuration, wherein a software program is designed to “learn” from its data inputs to generate new relevant data.

Related algorithms are known in prior art, so further detail is unnecessary. The required formula allows that a desired atomic change result is defined as a target at the end of a variable set drawn from classification of the known proton, electron, and neuron makeup of elements in the periodic table. Frequency waves are applied per the apparatus and methods described within the embodiments of the present invention, and observed atomic changes are classified in a database matrix associating input waves with output results.

Database 5 may expand arithmetically or logarithmically as active resonant frequencies are defined, and the associated changes in transmitted, absorbed, and reflected frequencies are catalogued and applied. For example, to vaporize a piece of aluminum, it may be necessary to combine three base frequencies with fifty levels of harmonics, layered in non-uniform amplitudes, and coupled with multi-level shifted adjacent spectra, as well as an overdriven inverted base frequency wave combined with other dissonant frequency components to achieve the desired results. An example of a typical “N” variable learning algorithm presented by the University of Texas at Arlington, Department of Engineering, is as follows:

Basis functions for a neural net are the inputs, hidden unit outputs, and the constant 1. These can be stored in the random vector x, which has dimension Nᵤ=N+Nₕ+1. Here, N is the number of network inputs, Nₕ is the number of network hidden units, and M is the number of network outputs. Thus x is the input vector, augmented by a constant and by hidden unit outputs. The inner product of the ith unit with the jth unit, following the definition of Papoulis (in Probability, Random Variables, and Stochastic Processes, McGraw-Hill, 1965, p. 220), is

<xₘ, xⱼ>≡E[xₘ·xⱼ]

which is approximated as

$$E [ {x}_{m} \cdot {x}_{j} ] \approx \frac{1}{N} {\sum }_{p = 1}^{{N}_{v}} {x}_{pm} \cdot {x}_{pj}$$

where xₚₘ denotes the mth unit's output for the pth pattern and Nᵥ denotes the number of training patterns. Letting tᵢ and yᵢ respectively denote the desired and actual ith outputs of a neural network, the training error for the ith output is

$$\begin{matrix}{E}_{i} ≡ E [ {( {y}_{i} - {t}_{i} )}^{2} ] \\ = < ( {y}_{i} - {t}_{i} ) , ( {y}_{i} - {t}_{i} ) > \approx \frac{1}{N} {\sum }_{p = 1}^{{N}_{v}} ( {y}_{pi} - {t}_{pi} ) where {y}_{i} is \\ {y}_{i} = {\sum }_{m = 1}^{{N}_{H}} {w}_{o} ( i , m ) {x}_{m}\end{matrix}$$

where yᵢ is

Using inner product notation, the norm squared of x and the norm of x are respectively ∥x∥²=<x,x>and ∥x∥=[<xx>]^{1/2}.

Those frequency waves 3 that are absorbed by a specimen 20 are its “active natural resonance” fundamental frequencies. “Overdriving” the amplitude of said frequencies with respect to the base rate of absorption using frequency generator 7, may result in the disruption of electrostatic and electromagnetic bonds within the atomic structure of specimen 20—in turn resulting in effects including crystallization, melting, shattering, and other state changes of the material. Further, the addition of frequency inversions, harmonics, dissonance, and offsets of said “overdriving” frequencies, to said overdriving frequencies, may result in electrical polarization effects which may be applied to effect magnetic propulsion, and catalytic material bonding and alloying. Combinations of the foregoing functions may allow transmutation effects.

For any material or specimen 20, there is a “key” fundamental active natural resonance frequency which may be manipulated and augmented by the present invention to catalyze modification of the molecular structure. In the case of complex molecules, including organic tissues, there is a hierarchy of atomic elements which determine the mechanics of transmutation. Initially altering a single specific molecular or atomic structure within a specimen 20, and concurrently altering the ensuing applied frequencies, may then propagate state changes in all the associated structures. For example, if a molecule is comprised of ten atomic elements arranged in a particular way, modifying the polarity of the third most prevalent atomic element in the molecule will have a different effect than modifying the first most prevalent—and vice versa.

By manipulating all segments of the frequency spectrum, and applying open and closed loop frequency feedback generation and modulation effects to the transmitted, reflected, absorbed, and especially active natural resonant frequency feedback data set 16 frequencies as they pass through atomic structures, atomic electromagnetic and structural changes may take effect. By classifying the changes—and rate of changes—in the reflected and transmitted frequencies, it may be possible to adjust the applied active frequencies to catalyze continuous, partial, or compound atomic and molecular changes. Arrays of frequencies 3, 9, 12, and 13 that may induce desired results in a specimen 20 are specified by system 15, and loaded back into broadband frequency generator 7 by system 15. Generator 7 energizes transducers 6 and the required modification of a specimen 20 may then be achieved by this closed loop frequency feedback mechanism.

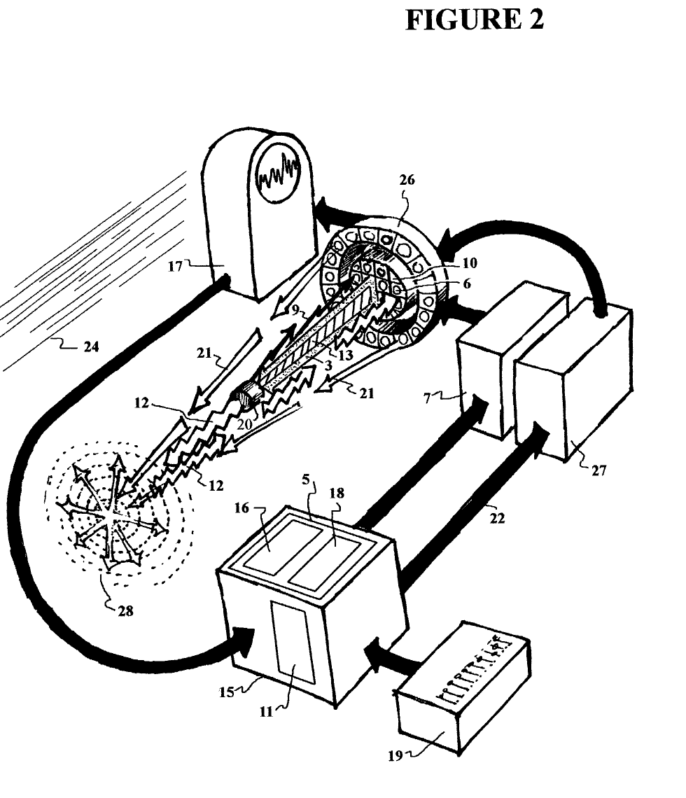

The atomic structure recognition and modification apparatus as presented in FIG. 2 is similar to that embodied in FIG. 1—except that no material analysis chamber is used. Numerical indicators relevant to apparatus elements used in FIG. 1 which are also used in FIG. 2 are maintained in FIG. 2. New elements are given new numbers. In this embodiment, a closed loop frequency feedback mechanism is described wherein a second frequency generating means 27, electrically coupled to system 15 and transducers 26, may be included, and said combination configured to transmit and project single or multiple frequency waves 21, combined with frequency inversions, and single or multiple harmonics, inversions, and dissonances of said frequency waves at variable amplitudes, at a given point in space separated from, but relative to the physical location of a specimen 20 to provide a resonant inverse barrier wave 28 tuned to create a frequency reflection effect in any ambient environment 24 surrounding said specimen 20 such that any transmitted frequency waves 12, output by transducer 6, that pass through said specimen 20, may be returned to, and sensed by transducer 10.

Prior art includes technologies which cancel sound waves and other frequency waves (radar jammers) by projecting a frequency wave set designed to negate another frequency wave set. Using a similar yet enhanced approach, the present invention utilizes a precisely structured wave set transmitted by frequency generator 27 that, in conjunction with the frequency transmission, absorption, and reflection characteristics of a given ambient environment 24, acts as a “frequency mirror” to reflect frequency waves propagated by frequency generator 7 back through transducers 10 to spectrum analyzer 17 to increase the transmitted frequency wave 12 data relevant in database 5 to the composition of any specimen 20 which is located within ambient environment 24.

A frequency generator 27 may also be controlled by system 15 to create a frequency neutral “buffer” zone where frequency generator 7 outputs have no effect. In this usage, generator 27 may be configured to transmit and project single or multiple frequency waves 21, combined with single or multiple harmonics, inversions, and dissonances of said frequency waves through transducers 26 at variable amplitudes, at a given point in space separated from, but relative to the physical location of a specimen 20 to provide a neutral polarity buffer zone effect within a resonant inverse barrier wave 28 to allow a controlled ambient disconnection to exist between a specimen 20 and the ambient environment 24 by at least the space of one full atom or molecule during operation of the present invention. This effect may be especially useful in the spacecraft, land mine elimination, missile tracking and elimination, and sentient organism affecting methods presented in the present invention descriptions and claims.

The embodiments of the present invention as illustrated in FIGS. 1 and 2 are intended to allow observation of complex resonance effects provided by combinations of frequencies on many types of materials. Additionally, many matter transmutation effects may also be achieved including negative or positive electrostatic or electromagnetic, polarization in a solid, liquid, or gaseous specimen 20, as well as crystallization, state change, transmutation, and atomic or other sub-component alterations. The range of effects and the level of accuracy of the present invention are predicated on the resolution of the frequency generators 7, and 27, and transducers 6, 8, 10, and 26, as well as the depth of resolution of database 5 for the structure of any specimen 20. The computational horsepower of computer system 15 is also not trivial. Since the invention is intended to provide real time atomic structure identification and manipulation, it is imperative that the computational portion of the system be configured for said purpose. State of the art computers may be powerful enough to satisfy the computational requirements of the present invention.

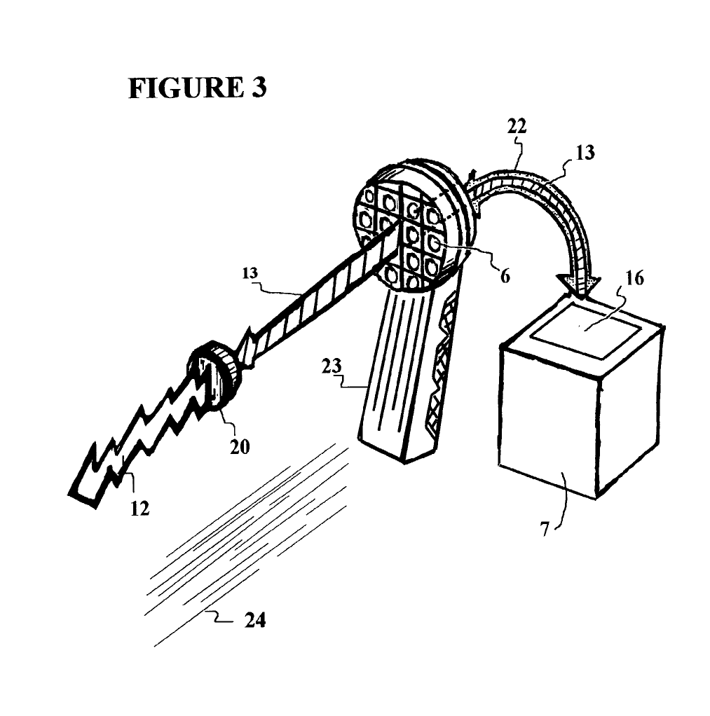

The atomic structure modification apparatus as presented in FIG. 3 is similar to that embodied in FIG. 2—except that the effectiveness of said embodiment is limited to those specimen 20 materials for which a known active resonance frequency feedback data set 16 has been loaded into generator 7. Numerical indicators relevant to apparatus elements used in FIGS. 1 and 2 which are also used in FIG. 3 are maintained in FIG. 3. New elements are given new numbers. This embodiment may be especially useful in the spacecraft, land mine elimination, missile tracking and elimination, organic growth stimulation, and sentient organism affecting methods presented in the present invention descriptions and claims.

In this embodiment, an open loop frequency transmission mechanism is described wherein a frequency generating means 7, electrically coupled to transducers 6, may be included, and said combination configured to transmit and project single or multiple absorbed frequency waves 13, combined with frequency inversions, and single or multiple harmonics, inversions, and dissonances of said absorbed frequency waves 13 at variable amplitudes, at a given point in space separated from transducers 6, but relative to the physical location of a specimen 20 to modify the atomic and molecular characteristics of said specimen 20 within an ambient environment 24. A handle assembly 23 is provided so that an operator may aim the apparatus.

The embodiment of the present invention as illustrated in FIG. 3 is intended to allow many matter transmutation effects including negative or positive electrostatic or electromagnetic polarization in a solid, liquid, or gaseous specimen 20, as well as crystallization, state change, transmutation, and atomic or other sub-component alterations. The range of effects and the level of accuracy of the present invention are predicated on the resolution of the frequency generator 7 and transducers 6—as well as the depth of resolution of active resonance frequency feedback data set 16 which is internally loaded within said generator 7.

Though the system description of the present invention is presented as straightforward apparatus in FIGS. 1 and 2 and 3, achieving the desired matter classification and transmutation results are predicated on following an extensive path of research while using the present invention as a tool set. Additionally, the present invention provides the tool set foundation that allows for the development and refinement of “fixed” resultant technologies that will provide the specific devices, effects, and capabilities disclosed in the description of other related embodiments presented in the present invention descriptions and claims.

In many circumstances, it may be necessary to use the present invention to create a “Catalytic Transmutation Propagation Wave” for applications such as long range missile guidance system destruction, remote land mine detonation, weather modification, etc. Said “Catalytic Transmutation Propagation Wave” is most easily defined as an effect similar to mixing hardener with acrylic resin, or mixing two epoxy components together. When a primary atomic or molecular structure is targeted for modification, a frequency wave set built on frequency waves 3, 13, and outputs from frequency feedback wave data base 16 is generated that, when applied to said structure, initiates a cascading component, electromagnetic, or electrostatic shift that results in a total change of the targeted media from an initial frequency wave burst. The effect continues until dissipated through a change in ambient media, or introduction of a cancellation frequency wave set. This “Catalytic Transmutation Propagation Wave” structure is also a key capability of the preferred embodiment of the present invention.

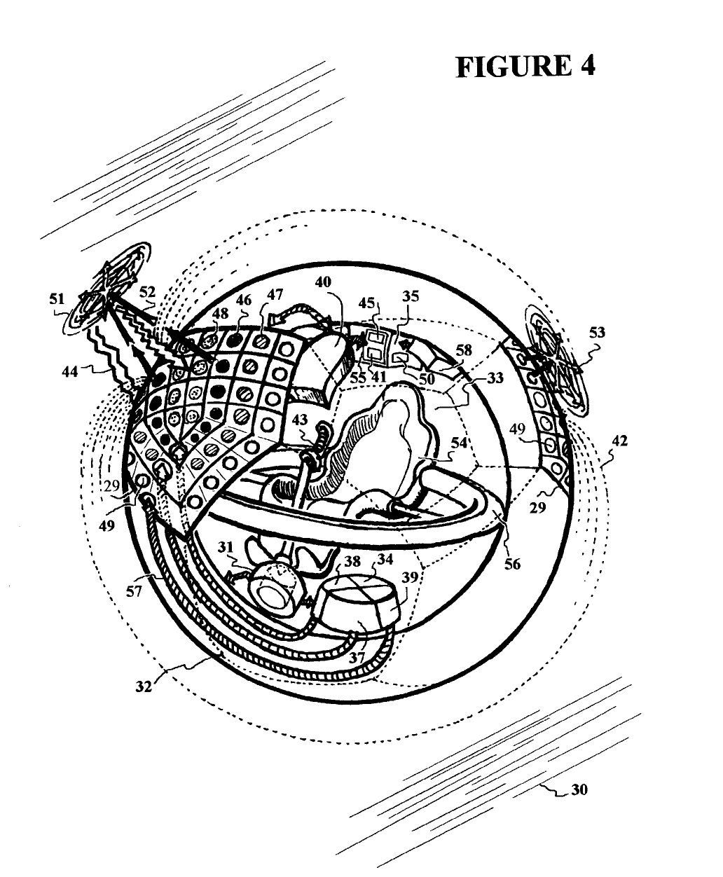

The preferred embodiment of a surface propulsion vehicle or spacecraft drive in accordance with the present invention as shown in FIG. 4 will provide a unique form of vehicle propulsion, the speed of which is not necessarily limited by the speed of light, but only limited by the true structure of the universe itself. Light is merely a sub-component of three dimensional realities, so therefore it cannot in itself define any structural limitation of the dimension. The actual speed limit is defined by the true dimensional structure itself, which is still being determined and understood. The wide range of observable frequency spectra clearly categorize light as a multiple and/or harmonic extension of sound. Sound does not set any speed limits of matter, so why should light?

The design philosophy behind this embodiment of the present invention combines standard airfoil, magnetic field induction and propagation, and electric motor design. In a typical airfoil, a high pressure area and a low pressure area wrap a controllable surface to provide lift and direction for a vehicle. The required lift is generated by the shape of the airfoil and the speed of the vehicle through the air. In an electric motor, power is generated by applying interactive magnetic fields to two separate surfaces. In the present invention, lift and direction are created by inducing a magnetic field in a surrounding medium to emulate high and low pressure zones around an electromagnetically polarized vehicle shell, which emulates an airfoil. The combination emulates an electromagnetic drive operational in liquid, atmospheres, and in free space.

Inducing a magnetic field in media that are normally non-magnetic is known in several areas of prior art. Eddy current generators use a spinning magnet to induce magnetic fields in aluminum and other metals. Static electrical generators, the principle of which can be simply demonstrated by combing one's hair and having the hair be attracted to the comb as it is pulled away—provide other means to induce attractive and repulsive forces.

The present invention in FIG. 4 as described herein is a combination of several subsystems—many components of which are identical to those in the embodiments referenced by FIGS. 1 and 2—however, different numbers are assigned to the components in FIG. 4. A vehicle, having an exterior shell 32 and a vehicle interior 33 is provided. Said shell 32 may be symmetrically configured about two perpendicularly intersecting axes. This vehicle shell 32 may also devoid of any perpendicularly intersecting surfaces, such as a spherical or ovoid shape.

A magnetic field generator 31, capable of inducing either negative or positive electromagnetic polarization within a given medium, is integrated into the surface structure of vehicle shell 32. Magnetic field generator 31 may be powered by an energy source 34, which may be either alternating or direct current, but self contained within said vehicle shell 32. Said magnetic field generator may be an electromagnet or induction magnet array, or vehicle shell 32 may also be constructed of a magnetically polarized material which needs no additional external polarization from a magnetic field generator 31, but simply interacts with polarized fields in the surrounding medium 30 as generated by the present invention.

An open and/or closed loop frequency feed back system as described in the embodiments of the present invention referenced to FIGS. 1 and 2 may be used as the core of the surrounding medium polarization means described in this surface propulsion vehicle application. A series of broadband frequency generators 37, 38, and 39 are fixedly mounted within the interior 33 of vehicle shell 32. Power source 34, which may be either alternating or direct current, and self contained within the interior 33 of said vehicle shell 32, provides electrical energy to operate frequency generators 37, 38, and 39.

Frequency generator 37 is mechanically coupled inside vehicle interior 33, and electrically coupled to transducers 47 though an electrical conduit 57, and capable of generating single or multiple frequency waves 44 from DC to gigahertz ranges and above—combined with single or multiple harmonics, inversions, and dissonances in said frequency ranges at variable amplitudes. The resultant frequency waves 44 are projected through transducer/antennae array 47 at given points in space separated from, but precisely relative to, the surface of vehicle shell 32, at and through any surrounding medium 30. Said transducer/antennae array 47 is electrically coupled to frequency generator 37, and mechanically coupled inside vehicle interior 33.

In the context of the present invention as illustrated in FIG. 4, one or more frequency generator 37 means, as well as one or more transducer/antennae arrays 47, may provide the capability of transmitting one or more frequency wave 44 combinations to multiple areas simultaneously, of a surrounding medium 30 to induce negative or positive electrostatic or electromagnetic, polarization waves 42 in a liquid or gaseous surrounding medium 30.

Frequency receiving transducer/antennae array 48 is configured to sense any transmitted and reflected frequencies that both pass through, and are rejected by, any surrounding medium 30. Said transducer/antennae array 48 is electrically coupled to spectrum analyzer 40 through an electrical conduit 57, and mechanically coupled inside vehicle interior 33.

Spectrum analyzer 40, which is electrically coupled to transducer/antenna array 48, as well as computer processing system 35, performs an analog to digital conversion, as well as frequency amplitude analysis, on said frequency waves 44. Hardware and software spectrum analyzers, as well as microprocessor based computers, are well known in prior art, so there is no need to go into great detail on these components.

Computer processing system 35 is electrically coupled to a frequency generator 37, and may incorporate a real time software component 41 coded to specify and modify the frequency waves 44 and amplitudes of said wave outputs of a frequency generator 37. This type of software is used in prior art as automatic feedback reducing controls in microprocessor-based stage sound equipment to eliminate feedback from a performer's microphone. The type of software coding and level of detail in software reconfiguration to convert said software to be used in the present invention is not significant, and therefore not necessary to describe in detail. In a simplified embodiment of the present invention, these changes may also be “tuned” by analog style control 58—electrically coupled to generators 37 through an electrical conduit 57—which may be a graphic equalizer set well known in prior art.

The combination of spectrum analyzer 40 and system 35 is configured to quantify the absorbed, reflected, and transmitted, single or multiple frequency waves 44 created by generator 37, output by transducer/antennae array 47, and sensed by transducer/antennae array 48. Since the output of broadband frequency generator 37 is known through the setup of system 35, the frequencies absorbed by surrounding medium 30 can be determined by algorithms embodied within the software component 41 of system 35 that add together the reflected and transmitted frequencies in all spectra and subtract them from the total applied broadband frequency.

A closed loop frequency feedback data set 45 is created by retransmitting only the absorbed frequency waves defined by system 35, and classifying the resultant changes in the associated reflected and transmitted frequency waves. Said data set 45 is configured as a software subset of database 55 of “active natural resonant” frequencies that can be created for any given surrounding medium 30. The active natural resonant frequency makeup of the atomic and molecular structure of a surrounding medium 30 can then be defined by comparing the resultant data quantified by computer processing system 35 with its resident atomic and molecular identification lookup-table data set 50. Data set 50 may be continually enhanced as polarization effects are observed and quantified, and changes in the frequency waves 44 output by generator 37 and transducers 46 are catalogued and altered to affect the magnetic polarity in any surrounding medium 30.

Database 55 is structured as a continuously updateable database whose fields expand and records enlarge to encompass all atomic structure change data following frequency inputs generated by a frequency generator 37 toward a given surrounding medium 30. The basic algorithm for building database 55 is similar to a “neural net” configuration, wherein a software program is designed to “learn” from its data inputs to generate new relevant data. These algorithms are known in prior art, so further detail is unnecessary. A desired result is defined as a target at the end of a variable set drawn from known core effects observed following the application of active resonant frequency waves 52. Database 55 may expand arithmetically or logarithmically as active resonant frequencies are defined, and the associated changes in transmitted, absorbed, and reflected frequencies are catalogued and applied.

Those frequencies that are absorbed by a surrounding medium 30 are its “active natural resonance” fundamental frequencies. “Overdriving” the amplitude of said frequencies with respect to the base rate of absorption may result in the disruption of electrostatic and electromagnetic bonds within the atomic structure of surrounding medium 30. The addition of frequency inversions, harmonics, dissonance, and offsets of said “overdriving” frequencies, to said overdriving frequencies, may result in electrical polarization effects which may be applied to effect magnetic propulsion. For any surrounding medium 30, there is a “key” fundamental active natural resonance frequency which may be manipulated and augmented by the present invention to induce magnetic polarization of the molecular structure.

By classifying the changes—and rate of changes—in the associated reflected and transmitted frequencies, it may be possible to adjust the applied active frequency waves 44 to catalyze continuous polarization changes. Arrays of frequencies that may induce desired results in a surrounding medium 30 may then be loaded back a frequency generator 37 by system 35. Generator 37 then energizes a transducer/antennae array 47 and the required modification of a surrounding medium 30 may then be achieved by this closed loop frequency feedback mechanism.

Prior art includes technologies which cancel sound waves and other frequency waves (radar jammers) by projecting a frequency wave set designed to negate a particular wave set. Using a similar yet enhanced approach, the present invention provides a means to project such a precisely structured wave set transmitted by a frequency generator 38. Said waves are constructed in conjunction with the known frequency transmission, absorption, and reflection characteristics of a given surrounding medium 30, to act as a “frequency mirror” reflection wave 51 defined by database 55.

Frequency generator 38 is configured to establish said frequency mirror reflection wave 51 by generating and transmitting single or multiple frequencies, combined with single or multiple harmonics, inversions, and dissonances at adjustable amplitudes, and projecting the resultant frequency waves 52 at given points in space separated from, but precisely relative to, the surface of vehicle shell 32. Said frequency waves are output through transducer antennae array 46. Reflection wave 51 insures that frequencies transmitted by a frequency generator 37, and absorbed or transmitted by surrounding medium 30, will be reflected back to the frequency sensing transducer/antennae array 48 for classification by database 55.

Since the output of broadband frequency generator 37 is known, and the qualities of the reflection wave 51 are known, the atomic qualities of the surrounding medium 30 can be determined by classifying the reflected frequencies as a function of the amplitude differentials, and the speed of return and distance traveled in multiple directions through surrounding medium 30. To determine the frequencies absorbed by surrounding medium 30, neural net algorithms embodied within the software component of computer processing system 35 assess the differences between the reflected active resonant wave components and transmitted frequency waves 44 in all spectra and relate them to the total applied broadband frequency.

A third frequency generator 39 may also be utilized to create a neutral “buffer” zone barricade wave 53 where frequency generators 37 and 38 outputs' have no effect. Frequency generator 39 is also capable of generating and transmitting single or multiple frequencies, combined with single or multiple harmonics, inversions, and dissonances at adjustable amplitudes, and projecting the resultant frequency waves at given points in space separated from, but precisely relative to, the surface of vehicle shell 32. Said frequency waves are output through transducer antennae array 49. In the context of the present invention as illustrated in FIG. 4, frequency generator 39 will provide a barricade wave 53 to create a neutral polarity buffer zone within a surrounding medium 30 to allow a controlled depth force disconnection to exist between the vehicle shell 2 and the surrounding medium 30 during operation of the present invention.

Neutral polarity buffer zone barricade wave 53 separates the polarity of the vehicle surface from the polarity of the surrounding medium by at least the thickness of one full atom or molecule so that the vehicle is always in a state of “chasing the carrot” and “running from the enemy”—the carrot being the attraction polarity of the surrounding medium, and the enemy being the repulsive. For example, if the vehicle shell 32 were charged positive, and the surrounding medium 30 above the vehicle were charged negative while the surrounding medium 30 below the vehicle were charged positive, and the physical depth of total charges within said surrounding medium 30 provided enough net force to overcome the any gravity effects on the vehicle, the vehicle would take off straight up like a proverbial bat out of hell.

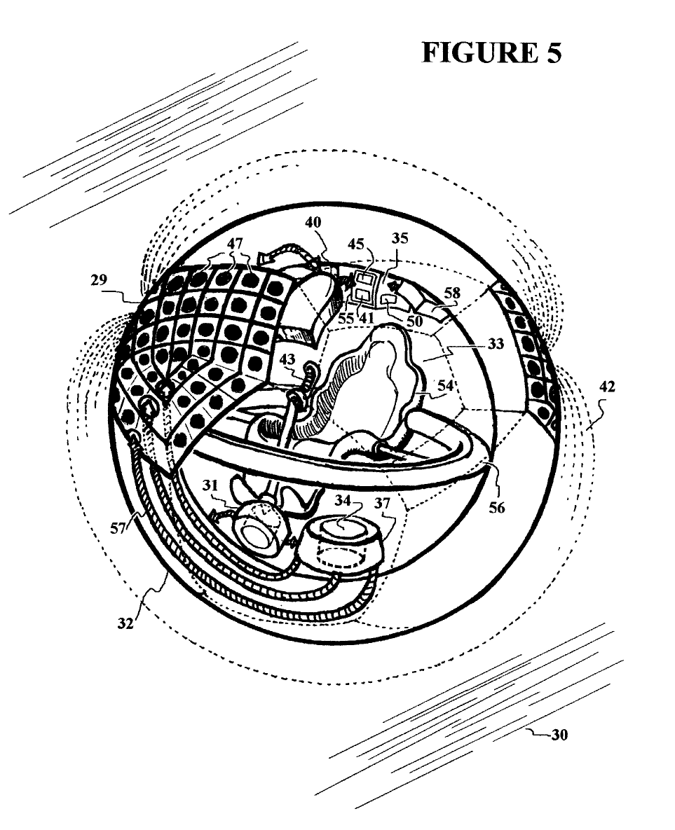

An electrical or mechanical “electromagnetic field” positioning system 43 is integrated into the vehicle interior 33 and electrically and mechanically coupled to any or all of frequency generators 37, 38, and 39, and configured to automatically, or allow an operator in seat assembly 54 mounted in inertial damper 56, to orient the waves generated by said frequency generators 37, 38, and 39, about multiple axes relative to, and at precise distances from, the surface of the vehicle shell 32. Transducers 46, 47, 48, and 49 may be mounted in dodecahedron shaped vehicle shell transducer mounting plate 29. The full surface of vehicle shell 52 may be covered with transducer mounting plates 29, however, for simplicity, FIGS. 4 and 5 show only two transducer mounting plates 29.

Computer processing system 35, which is electrically coupled to frequency generators 37, 38, and 39, and spectrum analyzer 40 through an electrical conduit 57, may be capable of interpreting all frequency wave data provided by spectrum analyzer 40 through transducer/antennae array 48, and using said data to modify the frequency outputs of all frequency generators 37, 38, and 39, and transducers 46, 47, and 49, in real time. Further, all frequency generators 37, 38, and 39—which are electrically coupled through electrical conduit 57 to transducers 46, 47, and 49—may perform exactly the same functions as one another if needed. Transducers 46, 47, and 49 may also perform exactly the same functions as one another if needed.

As a broadband frequency burst is directed at a gaseous or surrounding medium 30 by all frequency generators 37, 38, and 39, and transducers 46, 47, and 49, the wave spectra reflected, absorbed, and transmitted by surrounding medium 30 are sensed by frequency receiver transducer/antennae array 48. The outputs of said receiver transducer/antennae array 48 are fed to spectrum analyzer 40, which then outputs digital frequency makeup data to computer system 35. The data are compared to an elemental and atomic identification lookup table within database 55. Arrays of frequencies that will induce the desired polarization effect in surrounding medium 30 are then defined by system 55, and uploaded into frequency generators 37, 38, and 39. Frequency generators 37, 38, and 39 are energized with power source 34 and the required polarization effects on a surrounding medium 30 may then be achieved.

Another embodiment of a surface propulsion vehicle or spacecraft drive in accordance with the present invention is shown in FIG. 5. This vehicle configuration is vastly simpler that that presented in FIG. 4, however, numerical designations for identical parts are retained in FIGS. 4 and 5. This embodiment is useful for travel in known planetary or open space regions where the electromagnetic polarization requirements for the vacuum borne molecules, atmospheres, or liquid environments are known through prior analysis with an embodiment of the invention presented in FIG. 1, 2, or 4. A vehicle, having an exterior surface shell 32 and a vehicle interior 33 is provided. The vehicle shell 32 may be fabricated from passive, naturally electromagnetically polarized materials such as rare earth magnets. It may also be configured from any other man made material with permanent electromagnetically polarized characteristics.

One or more frequency generators 37 are mechanically coupled inside vehicle interior 33, and electrically coupled to one or more transducer/antennae arrays 47. Arrays of frequencies that may induce desired atomic or molecular component polarization effects in a surrounding medium 30 are preloaded into one or more frequency generators 37.

Generator 37 is capable of generating single or multiple frequency waves from DC to gigahertz ranges and above—combined with single or multiple harmonics, inversions, and dissonances in said frequency ranges at variable amplitudes. The resultant frequency waves are projected through transducer/antennae array 47 at given points in space separated from, but precisely relative to, the surface of vehicle shell 32, at and through any surrounding medium 30. Said transducer/antennae array 47 is electrically coupled to frequency generator 37, and mechanically coupled inside vehicle interior 33.

An electrical or mechanical “electromagnetic field” positioning system 43 is integrated into the vehicle interior 33 and electrically and mechanically coupled to frequency generators 37. System 43 is configured to automatically, or per the control of an operator in seat 54, to orient the waves generated by said frequency generators 37 about multiple axes relative to, and at precise distances from, the surface of the vehicle shell 32. If the vehicle shell 32 were natively charged positive, and the surrounding medium 30 above the vehicle were charged negative while the surrounding medium 30 below the vehicle were charged positive, and the physical depth of total charges within said surrounding medium 30 provided enough net force to overcome the any gravity effects on the vehicle, the vehicle would take off straight up like a proverbial bat out of hell.

It is to be understood that the embodiments and variations shown and described herein are merely illustrative of the principles of this invention and that various modifications may be implemented by those skilled in the art without departing from the scope and spirit of the invention.

I claim:

1. An atomic structure recognition and/or modification apparatus comprising in combination:
At least one frequency neutral specimen analysis chamber means comprising an interior space and an exterior shell,
At least one specimen containment structure means located within said frequency neutral specimen analysis chamber,
At least one first frequency generator means capable of outputting at least one frequency, or combinations of, base frequencies, harmonics, inversions, and dissonances spanning the subsonic, sound, light, radio, and other electromagnetic wavelength spectra,
At least one transmitting frequency transducer means mechanically coupled to said frequency neutral specimen analysis chamber, and electrically coupled to said first frequency generator, and capable of transmitting at least one frequency, or combinations of, base frequencies, harmonics, inversions, and dissonances spanning the subsonic, sound, light, radio, and other electromagnetic wavelength spectra,
At least one receiving frequency transducer means mechanically coupled to said frequency neutral specimen analysis chamber, and capable of sensing at least one frequency, or combinations of, base frequencies, harmonics, inversions, and dissonances spanning the subsonic, sound, light, radio, and other electromagnetic wavelength spectra,
At least one manual or programmable equalizer means capable of modifying at least one frequency, or combinations of, base frequencies, harmonics, inversions, and dissonances spanning the subsonic, sound, light, radio, and other electromagnetic wavelength spectra as generated by said first frequency generator means,
At least one spectrum analyzer means electrically coupled to said receiving frequency transducer means, and capable of analyzing the amplitude of at least one frequency, or combinations of, base frequencies, harmonics, inversions, and dissonances spanning the subsonic, sound, light, radio, and other electromagnetic wavelength spectra,
At least one computer means electrically coupled to said frequency generator means, said equalizer means, and said spectrum analyzer means, and configured with at least one software database means including the electron, proton, nuclear, and other known details of the atomic structure of at least one organic or inorganic substance, which may be contained within the specimen containment structure means located within said frequency neutral specimen analysis chamber means, including at least one “active” resonant frequency relevant to said substance which when generated, and applied to said substance through said transmitting transducer, may effect at least one change in the atomic or molecular characteristics of said substance, which change may include the electrostatic and electromagnetic polarization of said protons, electron, and neutron elements; and
Said computer means also containing operational software means coded to modify the outputs of said first frequency generator means to output at least one amplitude variation of at least one frequency, or amplitude variations of combinations of, base frequencies, harmonics, inversions, and dissonances spanning the subsonic, sound, light, radio, and other electromagnetic wavelength spectra.

2. An atomic structure recognition and/or modification apparatus comprising in combination:
At least one first frequency generator means capable of outputting at least one frequency, or combinations of, base frequencies, harmonics, inversions, and dissonances spanning the subsonic, sound, light, radio, and other electromagnetic wavelength spectra,
At least one transmitting frequency transducer means electrically coupled to said first frequency generator, and capable of transmitting at least one frequency, or combinations of, base frequencies, harmonics, inversions, and dissonances spanning the subsonic, sound, light, radio, and other electromagnetic wavelength spectra,
At least one receiving frequency transducer means capable of sensing at least one frequency, or combinations of, base frequencies, harmonics, inversions, and dissonances spanning the subsonic, sound, light, radio, and other electromagnetic wavelength spectra,
At least one manual or programmable equalizer means capable of modifying at least one frequency, or combinations of, base frequencies, harmonics, inversions, and dissonances spanning the subsonic, sound, light, radio, and other electromagnetic wavelength spectra as generated by said first frequency generator means,
At least one spectrum analyzer means electrically coupled to said receiving frequency transducer means, and capable of analyzing the amplitude of at least one frequency, or combinations of, base frequencies, harmonics, inversions, and dissonances spanning the subsonic, sound, light, radio, and other electromagnetic wavelength spectra,
At least one computer means electrically coupled to said frequency generator means, said equalizer means, and said spectrum analyzer means, and configured with at least one software database means including the electron, proton, nuclear, and other known details of the atomic structure of at least one organic or inorganic substance, which may be located in proximity to said transmitting and receiving frequency transducers, including at least one “active” resonant frequency relevant to said substance which when generated, and applied to said substance through said transmitting transducer, may effect at least one change in the atomic or molecular characteristics of said substance, which change may include the electrostatic and electromagnetic polarization of said protons, electron, and neutron elements, said computer means also containing operational software means coded to modify the outputs of said first frequency generator means to output at least one amplitude variation of at least one frequency, or amplitude variations of combinations of, base frequencies, harmonics, inversions, and dissonances spanning the subsonic, sound, light, radio, and other electromagnetic wavelength spectra;
At least one second frequency generating means configured to transmit single or multiple frequency waves, combined with single or multiple harmonics, inversions, and dissonances of said frequency waves at variable amplitudes, and able to project said frequency waves at a given point in space separated from, but relative to the physical location of said substance, and said second frequency generating means operating in synchronization with said first frequency generator means to provide a resonant inverse barrier wave tuned to create a frequency reflection effect in a medium surrounding said substance to allow said frequency sensing means to sense at least one frequency transmitted by said first frequency generator through said surrounding medium and through said substance; and
said computer means configured with frequency analyzing software means coded to quantify, in a database, the atomic makeup of said substance by assessing the characteristics of absorbed, reflected, and transmitted levels of the frequency waves received by said frequency sensing means, and said computer processing means electrically coupled to said first and second frequency generators and configured to use said database to modify the frequency outputs of said first and second frequency generators to transmit a specific frequency wave, or combination of frequency waves through said surrounding medium.

3. An atomic structure recognition and/or modification apparatus according to claim 1 which integrates a visual observation mechanism.

4. An atomic structure recognition and/or modification apparatus according to claim 2 which integrates a visual observation mechanism.

5. An atomic structure modification apparatus comprising in combination:
at least one frequency neutral specimen analysis chamber means comprising an interior space and an exterior shell,
at least one specimen containment structure means located within said frequency neutral specimen analysis chamber configured to contain an atomic structure,
at least one frequency generator means capable of outputting at least one frequency wave, or frequency wave combination configured by the addition or subtraction of at least one frequency wave amplification, harmonic, dissonance, inversion, and/or offset of said frequency wave to or from said frequency wave; and
at least one transmitting frequency transducer means mechanically coupled to said frequency neutral specimen analysis chamber, and electrically coupled to said first frequency generator, and capable of transmitting at least one frequency, or frequency wave combination configured by the addition or subtraction of at least one frequency wave amplification, harmonic, dissonance, inversion, and/or offset of said frequency wave to or from said frequency wave.

6. An atomic structure modification apparatus comprising in combination:
at least one frequency generator means capable of outputting at least one frequency wave, or frequency wave combination configured by the addition or subtraction of at least one frequency wave amplification, harmonic, dissonance, inversion, and/or offset of said frequency wave to or from said frequency wave; and
at least one transmitting frequency transducer means electrically coupled to said first frequency generator, and capable of transmitting at least one frequency, or frequency wave combination configured by the addition or subtraction of at least one frequency wave amplification, harmonic, dissonance, inversion, and/or offset of said frequency wave to or from said frequency wave.

7. An atomic structure modification apparatus according to claim 6 which incorporates;
At least one second frequency generating means configured to transmit single or multiple frequency waves, combined with single or multiple harmonics, inversions, and dissonances of said frequency waves at variable amplitudes, and able to project said frequency waves at a given point in space separated from, but relative to the physical location of said atomic structure, and said second frequency generating means operating in synchronization with said first frequency generator means to provide a resonant inverse barrier wave tuned to create a frequency reflection effect in a medium surrounding said atomic structure.

8. An atomic structure recognition and/or modification apparatus according to claim 1 configured to cut through solid objects.

9. An atomic structure recognition and/or modification apparatus according to claim 1 configured to focus and dramatically amplify the release of energy naturally embodied within matter.

10. An atomic structure recognition and/or modification apparatus according to claim 1 configured to rearrange the electrons and protons in a radioactive material to modify the radioactive output from a radioactive material such “spent” uranium fuel rods to increase or reduce said radioactive output.

11. An atomic structure recognition and/or modification apparatus according to claim 1 configured to modify materials other than radioactive materials for use as fuel sources in nuclear reactor style energy producing environments.

12. An atomic structure recognition and/or modification apparatus according to claim 1 configured to transmute toxic chemical compounds into non-toxic media.

13. An atomic structure recognition and/or modification apparatus according to claim 1 configured to produce alloys of similar and/or dissimilar elements.

14. An atomic structure recognition and/or modification apparatus according to claim 1 configured to split water into its hydrogen and oxygen subcomponents.

15. An atomic structure recognition and/or modification apparatus according to claim 1 configured to affect the nervous systems of biological organisms.

16. An atomic structure recognition and/or modification apparatus according to claim 1 configured to detonate land mines from a distance.

17. An atomic structure recognition and/or modification apparatus according to claim 1 configured to neutralize the functions of electronic devices from a distance.

18. An atomic structure recognition and/or modification apparatus according to claim 1 configured to neutralize the triggering and guidance systems in missiles and other “smart” vehicles.

19. An atomic structure recognition and/or modification apparatus according to claim 1 configured to affect the chemical makeup and/or genetic attributes of organic matter.

20. An atomic structure recognition and/or modification apparatus according to claim 2 configured to cut through solid objects.

21. An atomic structure recognition and/or modification apparatus according to claim 2 configured to focus and dramatically amplify the release of energy naturally embodied within matter.

22. An atomic structure recognition and/or modification apparatus according to claim 2 configured to rearrange the electrons and protons in a radioactive material to modify the radioactive output from a radioactive material such “spent” uranium fuel rods to increase or reduce said radioactive output.

23. An atomic structure recognition and/or modification apparatus according to claim 2 configured to modify materials other than radioactive materials for use as fuel sources in nuclear reactor style energy producing environments.

24. An atomic structure recognition and/or modification apparatus according to claim 2 configured to transmute toxic chemical compounds into non-toxic media.

25. An atomic structure recognition and/or modification apparatus according to claim 2 configured to produce alloys of similar and/or dissimilar elements.

26. An atomic structure recognition and/or modification apparatus according to claim 2 configured to split water into its hydrogen and oxygen subcomponents.

27. An atomic structure recognition and/or modification apparatus according to claim 2 configured to affect the nervous systems of biological organisms.

28. An atomic structure recognition and/or modification apparatus according to claim 2 configured to detonate land mines from a distance.

29. An atomic structure recognition and/or modification apparatus according to claim 2 configured to neutralize the functions of electronic devices from a distance.

30. An atomic structure recognition and/or modification apparatus according to claim 2 configured to neutralize the triggering and guidance systems in missiles and other “smart” vehicles.

31. An atomic structure recognition and/or modification apparatus according to claim 2 configured to affect the chemical makeup and/or genetic attributes of organic matter.

32. An atomic structure recognition and/or modification apparatus according to claim 5 configured to cut through solid objects.

33. An atomic structure recognition and/or modification apparatus according to claim 5 configured to focus and dramatically amplify the release of energy naturally embodied within matter.

34. An atomic structure recognition and/or modification apparatus according to claim 5 configured to rearrange the electrons and protons in a radioactive material to modify the radioactive output from a radioactive material such “spent” uranium fuel rods to increase or reduce said radioactive output.

35. An atomic structure recognition and/or modification apparatus according to claim 5 configured to modify materials other than radioactive materials for use as fuel sources in nuclear reactor style energy producing environments.

36. An atomic structure recognition and/or modification apparatus according to claim 5 configured to transmute toxic chemical compounds into non-toxic media.

37. An atomic structure recognition and/or modification apparatus according to claim 5 configured to produce alloys of similar and/or dissimilar elements.

38. An atomic structure recognition and/or modification apparatus according to claim 5 configured to split water into its hydrogen and oxygen subcomponents.

39. An atomic structure recognition and/or modification apparatus according to claim 5 configured to affect the nervous systems of biological organisms.

40. An atomic structure recognition and/or modification apparatus according to claim 5 configured to detonate land mines from a distance.

41. An atomic structure recognition and/or modification apparatus according to claim 5 configured to neutralize the functions of electronic devices from a distance.

42. An atomic structure recognition and/or modification apparatus according to claim 5 configured to neutralize the triggering and guidance systems in missiles and other “smart” vehicles.

43. An atomic structure recognition and/or modification apparatus according to claim 5 configured to affect the chemical makeup and/or genetic attributes of organic matter.

44. An atomic structure recognition and/or modification apparatus according to claim 6 configured to cut through solid objects.

45. An atomic structure recognition and/or modification apparatus according to claim 6 configured to focus and dramatically amplify the release of energy naturally embodied within matter.

46. An atomic structure recognition and/or modification apparatus according to claim 6 configured to rearrange the electrons and protons in a radioactive material to modify the radioactive output from a radioactive material such “spent” uranium fuel rods to increase or reduce said radioactive output.

47. An atomic structure recognition and/or modification apparatus according to claim 6 configured to modify materials other than radioactive materials for use as fuel sources in nuclear reactor style energy producing environments.

48. An atomic structure recognition and/or modification apparatus according to claim 6 configured to transmute toxic chemical compounds into non-toxic media.

49. An atomic structure recognition and/or modification apparatus according to claim 6 configured to produce alloys of similar and/or dissimilar elements.

50. An atomic structure recognition and/or modification apparatus according to claim 6 configured to split water into its hydrogen and oxygen subcomponents.

51. An atomic structure recognition and/or modification apparatus according to claim 6 configured to affect the nervous systems of biological organisms.

52. An atomic structure recognition and/or modification apparatus according to claim 6 configured to detonate land mines from a distance.

53. An atomic structure recognition and/or modification apparatus according to claim 6 configured to neutralize the functions of electronic devices from a distance.

54. An atomic structure recognition and/or modification apparatus according to claim 6 configured to neutralize the triggering and guidance systems in missiles and other “smart” vehicles.

55. An atomic structure recognition and/or modification apparatus according to claim 6 configured to affect the chemical makeup and/or genetic attributes of organic matter.

56. A database which incorporates the following information in combination:
classification of the transmitted, reflected, and absorbed frequency wave amplitudes of at least one frequency wave applied to at least one atomic structure;
classification of the rates of transmission, reflection, and absorption of said frequency wave applied to said atomic structure;
classification of the effects caused by modifying said absorbed frequency wave with respect to the base rate of said frequency wave absorption on said atomic structure following the addition or subtraction of at least one fundamental frequency wave amplification, harmonic, dissonance, inversion, and/or offset of said fundamental frequency wave to or from said fundamental frequency wave;
classification of at least one effect on the net change characteristics of the combined frequency waves transmitted, reflected, and/or absorbed by said atomic and/or molecular structure following the addition or subtraction of at least one fundamental frequency wave amplification, harmonic, dissonance, inversion, and/or offset of said fundamental frequency wave to or from said fundamental frequency wave.

57. A database according to claim 56 that is a neural net database.

58. A database according to claim 56 that is used in an atomic structure recognition and/or modification apparatus.

59. A method of identifying an atomic and/or molecular structure that includes in combination;
classifying the transmitted, reflected, and absorbed frequency wave amplitudes of at least one frequency wave applied to at least one atomic structure;
classifying the rates of transmission, reflection, and absorption of said frequency wave applied to said atomic structure;
classifying the effects caused by modifying said absorbed frequency wave with respect to the base rate of said frequency wave absorption on said atomic structure following the addition or subtraction of at least one fundamental frequency wave amplification, harmonic, dissonance, inversion, and/or offset of said fundamental frequency wave to or from said fundamental frequency wave; and
classifying at least one effect on the net change characteristics of the combined frequency waves transmitted, reflected, and/or absorbed by said atomic and/or molecular structure following the addition or subtraction of at least one fundamental frequency wave amplification, harmonic, dissonance, inversion, and/or offset of said fundamental frequency wave to or from said fundamental frequency wave.

60. A method of affecting the electrostatic and electromagnetic polarization of an atomic structure by:
applying at least one frequency wave combination to at least one atomic structure, wherein said
frequency wave combination is configured by the addition or subtraction of at least one frequency wave amplification, harmonic, dissonance, inversion, and/or offset of said frequency wave to or from said frequency wave.

61. A method of affecting the internal proton, electron, and neutron bonds identified within an atomic structure by:
applying at least one frequency wave combination to at least one atomic structure, wherein said
frequency wave combination is configured by the addition or subtraction of at least one frequency wave amplification, harmonic, dissonance, inversion, and/or offset of said frequency wave to or from said frequency wave.

62. A method of transmuting at least one molecular structure by:
applying at least one frequency wave combination to at least one atomic structure, wherein said
frequency wave combination is configured by the addition or subtraction of at least one frequency wave amplification, harmonic, dissonance, inversion, and/or offset of said frequency wave to or from said frequency wave.

63. A method of alloying at least two atomic structures by:
applying at least one frequency wave combination to at least one atomic structure, wherein said
frequency wave combination is configured by the addition or subtraction of at least one frequency wave amplification, harmonic, dissonance, inversion, and/or offset of said frequency wave to or from said frequency wave.

64. A method of transmuting at least one molecular structure by:
applying at least one frequency wave combination to at least one atomic structure, wherein said
frequency wave combination is configured by the addition or subtraction of at least one frequency wave amplification, harmonic, dissonance, inversion, and/or offset of said frequency wave to or from said frequency wave; and
adding at least one additional atomic component to initiate a molecular structure transmutation chain reaction.

65. A means to induce interactive propulsive forces in a vehicle surface and in a medium surrounding said vehicle surface comprising, in combination;
at least one vehicle means having an interior and an exterior with an exterior surface comprised of electromagnetically polarized material;
at least one electromagnetic polarity generating means mounted within said vehicle, and configured to induce either negative or positive electromagnetic charges on or within a medium surrounding said vehicle;
at least one positioning system coupled to said second electromagnetic polarity generating means, and configured to allow orientation in said surrounding medium of said negative or positive electromagnetic charges about multiple axes relative to said vehicle surface.

66. A means to induce interactive propulsive forces in a vehicle surface and in a medium surrounding said vehicle surface comprising, in combination;
at least one vehicle means having an interior and an exterior with an exterior surface comprised of electromagnetically polarizable material;
at least one first electromagnetic polarity generating means mounted within said vehicle, and configured to induce either negative or positive electromagnetic charges on or within said vehicle surface;
at least one positioning means coupled to said first electromagnetic polarity generating means, and configured to allow variable orientation of said negative or positive electromagnetic charges on said vehicle surface.
at least one second electromagnetic polarity generating means mounted within said vehicle, and configured to induce either negative or positive electromagnetic charges on or within a medium surrounding said vehicle;
at least one positioning system coupled to said second electromagnetic polarity generating means, and configured to allow orientation in said surrounding medium of said negative or positive electromagnetic charges about multiple axes relative to said vehicle surface.

67. A means to induce interactive propulsive forces in a vehicle surface and in a medium surrounding said vehicle surface comprising, in combination;
at least one vehicle means having an interior and an exterior with an exterior surface comprised of electromagnetically polarizable material;
at least one electromagnetic polarity generating means mounted within said vehicle, and configured to induce either negative or positive electromagnetic charges on or within said vehicle surface;
at least one positioning means coupled to said electromagnetic polarity generating means, and configured to allow variable orientation of said negative or positive electromagnetic charges on said vehicle surface.
at least one first frequency generator and transducer combination means mounted within said vehicle and configured to output and transmit at least one frequency, or a range of frequency waves through a medium surrounding said vehicle;
at least one positioning system coupled to said first frequency generator, and configured to allow orientation in said surrounding medium of said frequency waves generated by said frequency generator about multiple axes relative to said vehicle surface.
at least one frequency sensing means mounted within said vehicle and configured to receive the absorbed, reflected, and frequency waves transmitted by said first frequency generator through said medium surrounding said vehicle;
at least one computer means electrically coupled to said frequency sensing means, and mounted within the interior of said vehicle, and configured with a frequency analyzing means to classify the atomic makeup of said surrounding medium by analyzing the absorbed, reflected, and transmitted frequency waves received by said frequency sensing means, and said computer processing means electrically coupled to said first frequency generator means and configured to modify the frequency outputs of said first frequency generator means to transmit a specific frequency wave, or combination of frequency waves through said surrounding medium, such that said frequency waves electromagnetically polarize the atomic structure of said medium in a positionally variable manner relative to the position of the electromagnetic polarities applied to the surface of said vehicle by said electromagnetic polarity generating means.

68. A means to induce interactive propulsive forces in a vehicle surface and in a medium surrounding said vehicle surface according to claim 66 that includes in combination;
at least one second frequency generating and transducer combination means mounted in the interior of said vehicle, and second frequency generating and transducer combination means configured to transmit single or multiple frequency waves, combined with single or multiple harmonics and dissonances of said frequency waves at variable amplitudes, and able to project said frequency waves at a given point in space separated from, but relative to the physical location of said first frequency generator and said vehicle surface, and said second frequency generating means operating in synchronization with said first frequency generator to provide a resonant inverse barrier wave tuned to create a frequency reflection effect in said surrounding medium to allow said frequency sensing means mounted within said vehicle to sense at least one frequency transmitted by said frequency generator through said surrounding medium.

69. A means to induce interactive propulsive forces in a vehicle surface and in a medium surrounding said vehicle surface according to claim 66 that includes at least one third frequency generating and transducer combination means mounted in the interior of said vehicle, said third frequency generating and transducer combination means configured to transmit single or multiple frequency waves, combined with single or multiple harmonics and dissonances of said frequency waves at variable amplitudes, and able to project said frequency waves at a given area in space separated from, but relative to said vehicle surface, to create an electromagnetically neutral “buffer zone” effect in said surrounding medium.

70. A weightlessness inducing apparatus comprising in combination:
a means to identify the molecular structure of a sample of matter;
a means to identify the electrical polarization characteristics of said sample of matter;
a means to identify the electrical polarization characteristics of the ambient environment surrounding said sample of matter;
a transmitter means configured to output a multi-spectrum frequency beam configured to induce a reverse electrical polarity effect in said sample of matter relative to said electrical polarization characteristics of said sample of matter, and of the ambient environment surrounding said sample of matter;
a controller means to direct the output of said transmitter means to only effect specific portions of said sample of matter.
